(19) United States
(12) Patent Application Publication
(10) Pub. No.: US 2024/0357056 A1
(43) Pub. Date: Oct. 24, 2024

(54) Infant Monitoring Device

(71) Applicant: Terin Blanchard, Quincy, IL (US)

(72) Inventor: Terin Blanchard, Quincy, IL (US)

(21) Appl. No.: 18/457,410

(22) Filed: Aug. 29, 2023

Related U.S. Application Data
(60) Provisional application No. 63/460,998, filed on Apr. 21, 2023.

(51) Int. Cl. H04N 7/14

(52) U.S. Cl. CPC H04N 7/142; H04N 2007/145

(57) ABSTRACT

An infant monitoring device is provided. The device is comprised of a tablet that allows for two-way video chatting/monitoring from a parent/caregiver to an infant. The tablet can be received by a repositionable wall mount or free-standing mount. Functions of the tablet can be controlled by a mobile application, including the initiation of video chatting as well as repositioning the tablet within the mount.

### CROSS-REFERENCE TO RELATED APPLICATION

The present application claims priority to, and the benefit of, U.S. Provisional Application No. 63/460,998, which was filed on Apr. 21, 2023, and is incorporated herein by reference in its entirety.

### FIELD OF THE INVENTION

The present invention relates generally to the field of infant monitoring devices. More specifically, the present invention relates to an infant monitoring device that allows a parent/caregiver to monitor and/or video chat with an infant via a tablet secured within a repositionable mount and a mobile application. Accordingly, the present disclosure makes specific reference thereto. Nonetheless, it is to be appreciated that aspects of the present invention are also equally applicable to other like applications, devices, and methods of manufacture.

### BACKGROUND

Existing infant monitors known in the art, which are widely used by parents and caregivers, have proven to be effective in providing audio monitoring capabilities, allowing them to hear their child's sounds and respond promptly to their needs. However, these monitors fall short when it comes to providing a complete visual connection between the child and the parent or caregiver.

While the two-way audio feature of existing infant monitors allows for communication between the parent or caregiver and the child, it lacks an essential two-way video component. Consequently, although the parent or caregiver can observe and monitor the child through the video feed, the child is unable to reciprocate the visual connection and see the parent or caregiver. This limitation can result in a sense of disconnect and may even cause distress to the child.

In a scenario where a child hears the comforting voice of their parent or caregiver emanating from the infant monitor but cannot visually confirm their presence, the child may experience confusion, anxiety, or a feeling of separation, as their ability to connect the voice with a physical presence is hindered. This asymmetrical communication dynamic can be disorienting and potentially impact the child's emotional well-being, undermining the sense of security and reassurance that a comprehensive (two-way video) monitoring system should provide.

There is a clear need for infant monitors that go beyond audio-only capabilities and incorporate two-way video functionality. By allowing a child to see the parent or caregiver on a monitor screen, the child would not only be able to hear the voice of their parent or caregiver but also observe their facial expressions, gestures, and actions. This visual interaction can significantly enhance the child's perception of presence and improve their overall emotional well-being during times when physical proximity is not possible or convenient.

Therefore, there exists a long-felt need in the art for an improved infant monitoring device. More specifically, there exists a long-felt need in the art for an infant monitoring device that provides two-way video such that a parent and child can see one another. In addition, there exists a long-felt need in the art for an infant monitoring device that can be easily positioned on a wall or other surface.

The subject matter disclosed and claimed herein, in one embodiment thereof, comprises an infant monitoring device. The device is comprised of a tablet that allows for two-way video chatting/monitoring from a parent/caregiver to an infant. The tablet can be received by a repositionable wall mount or free-standing mount. Functions of the tablet can be controlled by a mobile application, including the initiation of video chatting as well as repositioning the tablet within the mount.

In this manner, the infant monitoring device of the present invention accomplishes all the foregoing objectives and provides an improved infant monitoring device. More specifically, the device can provide two-way video such that a parent and child can see one another. In addition, the device can be easily positioned on a wall or other surface via a wall mount or freestanding mount.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an infant monitoring device. The device is designed to allow a parent or caregiver to communicate with two-way audio and video with an infant the device is being used to monitor via at least one tablet. In various embodiments, the tablet may be wall-mounted or freestanding. The tablet is comprised of at least one electronic display screen that displays a real-time video feed (i.e., a video chat) of a parent/caregiver, that may be viewing an infant monitored by the device, via a mobile application for a smart device. Any words spoken by the parent/caregiver can be played from the tablet using at least one speaker of any type known in the art. The tablet is comprised of at least one camera that allows a parent/caregiver to observe an infant the device is monitoring using a mobile application. The tablet is also comprised of a microphone that allows a parent/caregiver to hear any sounds from the infant while monitoring the infant using the mobile application. The tablet is powered by at least one rechargeable battery with at least one charging port.

In two embodiments, the tablet may be received by a wall mount or free-standing mount. In a wall-mounted embodiment, at least one portion of the tablet is received by the receiving area of a wall mount. The receiving area is comprised of at least one charging port that provides charge to the tablet while receiving power from a 110 v/240 v power cord. The receiving area attaches to a frame of the wall mount via at least one rotation point that allows the receiving area (and thus secured tablet) to be tilted upwards, downwards, left, or right by at least one degree. In this manner, the tablet can be easily repositioned and angled towards an infant within a crib, bed, etc. The wall mount frame can then be secured to a wall via at least one fastener that penetrates at least one opening of the frame.

In a different embodiment, the tablet can be received by a free-standing mount with a frame that can rest on a flat surface. The tablet is received by the receiving area of a wall mount. The receiving area is comprised of at least one charging port that provides charge to the tablet while receiving power from a 110 v/240 v power cord. The receiving area attaches to a frame of the wall mount via at least one rotation point that allows the receiving to be tilted upwards, downwards, left, or right by at least one degree. In this manner, the tablet can be easily repositioned and angled towards an infant within a crib, a bed, etc.

As noted, the tablet is in wireless electrical communication with a mobile application installed on a smart device. The mobile application may allow a parent/caregiver to initiate a two-way video chat using the smart device camera and display and the camera and display of the tablet. Further, in an embodiment of the device with a mount having a motorized rotation point, the mobile application can be used to remotely move the rotation point to rotate the tablet to enable a better view of an infant being monitored with the device.

The present invention is also comprised of a first method of using the device. First, a device is provided comprised of a tablet comprised of a camera, a microphone, a speaker, a display screen, and a charging port, and a wall mount comprised of a receiving area with a charging port and a frame. Then, the frame can be attached to a wall (or another surface) using a fastener. Next, the tablet can be placed into the receiving area such that the charging port of the receiving area contacts the charging port of the tablet. Then, the receiving area can be rotated about a rotation point to position the tablet such that the display screen and camera can be seen by an infant. Finally, a mobile application can be used to video chat with the infant in real-time using the camera, microphone, speaker, and display screen.

In another method of using the device, a device is provided comprised of a tablet comprised of a camera, a microphone, a speaker, a display screen, and a charging port, and a free-standing mount comprised of a receiving area with a charging port and a frame. Then, the frame can be placed on a flat surface. Next, the tablet can be placed into the receiving area such that the charging port of the receiving area contacts the charging port of the tablet. Then, the receiving area can be rotated about a rotation point to position the tablet such that the display screen and camera can be seen by an infant. Finally, a mobile application can be used to video chat with the infant in real-time using the camera, microphone, speaker, and display screen.

Accordingly, the infant monitoring device of the present invention is particularly advantageous as it provides an improved infant monitoring device. More specifically, the device can provide two-way video such that a parent and child can see one another. In addition, the device can be easily positioned on a wall or other surface via a wall mount or freestanding mount. In this manner, the infant monitoring device overcomes the limitations of existing infant monitoring devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an infant monitoring device of the present invention and wall mount in accordance with the disclosed architecture;

FIG. 2 illustrates a perspective view of one potential embodiment of an infant monitoring device of the present invention and free-standing mount in accordance with the disclosed architecture;

FIG. 3 illustrates a graphical view of a mobile application of one potential embodiment of an infant monitoring device of the present invention in accordance with the disclosed architecture;

FIG. 4 illustrates a flowchart of a method of using one potential embodiment of an infant monitoring device of the present invention in accordance with the disclosed architecture; and

FIG. 5 illustrates a flowchart of a method of using one potential embodiment of an infant monitoring device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not show all the aspects or advantages. Thus, in other embodiments, any of the features described herein from different embodiments may be combined.

As noted above, there exists a long-felt need in the art for an improved infant monitoring device. More specifically, there exists a long-felt need in the art for an infant monitoring device that provides two-way video such that a parent and child can see one another. In addition, there exists a long-felt need in the art for an infant monitoring device that can be easily positioned on a wall or other surface.

The present invention, in one exemplary embodiment, is comprised of an infant monitoring device designed to allow a parent or caregiver to communicate with two-way audio and video with an infant the device is being used to monitor via at least one tablet. In various embodiments, the tablet may be wall-mounted or freestanding. The tablet is comprised of at least one electronic display screen that displays a real-time video feed (i.e., a video chat) of a parent/caregiver, that may be viewing an infant monitored by the device, via a mobile application for a smart device.

Any words spoken by the parent/caregiver can be played from the tablet using at least one speaker. The tablet is comprised of at least one camera that allows a parent/caregiver to observe an infant the device is monitoring using a mobile application. The tablet is also comprised of a microphone that allows a parent/caregiver to hear any sounds from the infant while monitoring the infant using the mobile application. The tablet is powered by at least one rechargeable battery with at least one charging port.

The tablet may be received by a wall mount or free-standing mount. In a wall-mounted embodiment, at least one portion of the tablet is received by a receiving area of a wall mount comprised of at least one charging port that provides charge to the tablet while receiving power from a 110 v/240 v power cord. The receiving area attaches to a frame of the wall mount via at least one rotation point that allows the receiving area (and thus secured tablet) to be tilted upwards, downwards, left, or right by at least one degree. In this manner, the tablet can be easily repositioned and angled towards an infant within a crib, a bed, etc. The wall mount frame can then be secured to a wall via at least one fastener that penetrates at least one opening of the frame.

In a different embodiment, the tablet can be received by a free-standing mount with a frame that can rest on a flat surface. The tablet is received by a receiving area of a wall mount. The receiving area is comprised of at least one charging port that provides charge to the tablet while receiving power from a 110 v/240 v power cord. The receiving area attaches to a frame of the wall mount via at least one rotation point that allows the receiving to be tilted upwards, downwards, left, or right by at least one degree. In this manner, the tablet can be easily repositioned and angled towards an infant within a crib, a bed, etc.

The tablet is in wireless electrical communication with a mobile application installed on a smart device that may allow a parent/caregiver to initiate a two-way video chat using the smart device camera and display and the camera and display of the tablet. Further, in an embodiment of the device with a mount having a motorized rotation point, the mobile application can be used to remotely move the rotation point to rotate the tablet to enable a better view of an infant being monitored with the device.

The present invention is also comprised of a first method of using the device. First, a device is provided comprised of a tablet comprised of a camera, a microphone, a speaker, a display screen, a charging port, and a wall mount comprised of a receiving area with a charging port and a frame. Then, the frame can be attached to a wall (or another surface) using a fastener. Next, the tablet can be placed into the receiving area such that the charging port of the receiving area contacts the charging port of the tablet. Then, the receiving area can be rotated about a rotation point to position the tablet such that the display screen and camera can be seen by an infant. Finally, a mobile application can be used to video chat with the infant in real-time using the camera, microphone, speaker, and display screen.

In another method of using the device, a device is provided comprised of a tablet comprised of a camera, a microphone, a speaker, a display screen, and a charging port, and a free-standing mount comprised of a receiving area with a charging port and a frame. Then, the frame can be placed on a flat surface. Next, the tablet can be placed into the receiving area such that the charging port of the receiving area contacts the charging port of the tablet. Then, the receiving area can be rotated about a rotation point to position the tablet such that the display screen and camera can be seen by an infant. Finally, a mobile application can be used to video chat with the infant in real-time using the camera, microphone, speaker, and display screen.

Accordingly, the infant monitoring device of the present invention is particularly advantageous as it provides an improved infant monitoring device. More specifically, the device can provide two-way video such that a parent and child can see one another. In addition, the device can be easily positioned on a wall or other surface via a wall mount or freestanding mount. In this manner, the infant monitoring device overcomes the limitations of existing infant monitoring devices known in the art.

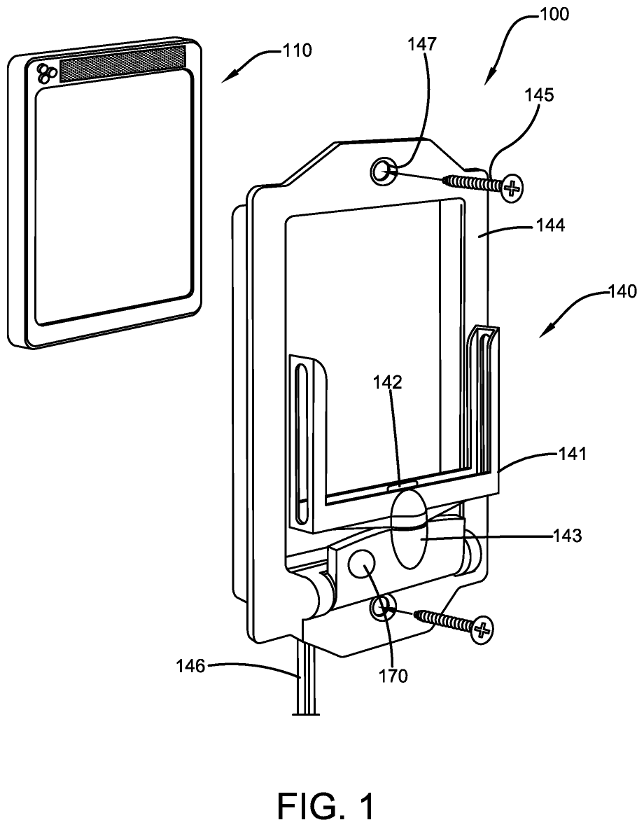

Referring initially to the drawings, FIG. 1 illustrates a perspective view of one potential embodiment of an infant monitoring device 100 of the present invention and wall mount 140 in accordance with the disclosed architecture. The device 100 is designed to allow a parent or caregiver to communicate with two-way audio and video with an infant the device 100 is being used to monitor via at least one tablet 110. In various embodiments, the tablet 110 may be wall-mounted or freestanding.

The device 100 is primarily comprised of at least one tablet 110. The tablet 110 is comprised of at least one electronic display screen 111 (of any type known in the art) such as, but not limited to, an LED screen, a touch screen, etc. The display screen 111 displays a real-time video feed (i.e., a video chat) of a parent/caregiver, that may be viewing an infant monitored by the device 100, via a mobile application 160 for a smart device such as, but not limited to, a smartphone. Any words spoken by the parent/caregiver can be played from the tablet 110 using at least one speaker 114 of any type known in the art. In one embodiment, the display 111 can also be used to show videos, photos, shows, etc. to an infant. Furthermore, the tablet 110 may be comprised of at least one external light 115 that functions as a night light.

The tablet 110 is comprised of at least one camera 112. The camera 112 allows a parent/caregiver to observe an infant the device 100 is monitoring using a mobile application 160. The camera 112 may be any camera type known in the art, including, but not limited to, a low-light camera for nighttime monitoring.

The tablet 110 is also comprised of a microphone 113. The microphone 113 may be any type known in the art. The microphone 113 allows a parent/caregiver to hear any sounds from the infant while monitoring the infant using the mobile application 160.

The tablet 110 can be powered on/off via at least one button 116, which may also control any and all functions of the tablet 110. The tablet 110 is powered by at least one rechargeable battery 117 with at least one charging port 118. The charging port 118 is preferably, but not limited to, a USB port.

In two embodiments, the tablet 110 may be received by a wall mount 140 or free-standing mount 150. In a wall-mounted embodiment, at least one portion of the tablet 110 is received by a receiving area 141 of a wall mount 140. The receiving area 141 may be in the form of a cradle, a molded area, or any other tablet 110 holding means known in the art. The receiving area 141 is comprised of at least one charging port 142, which is a reciprocating charging port to the charging port 118 of the tablet 110 and provides charge to the tablet 110 while receiving power from a 110 v/240 v power cord 146.

The receiving area 141 attaches to a frame 144 of the wall mount 140 via at least one rotation point 143. The point 143 may be a hinge, a ball and socket joint, or any other rotation point of the like that allows the receiving area 141 (and thus secured tablet 110) to be tilted upwards, downwards, left, or right by at least one degree. In this manner, the tablet 110 can be easily repositioned and angled towards an infant within a crib, a bed, etc.

The wall mount 140 frame 144 can then be secured to a wall via at least one fastener 145 that penetrates at least one opening 147 of the frame 144. The fastener 145 may be any type known in the art but is preferably a screw, a drywall anchor, etc. Alternatively, a non-penetrative version of the fastener 145 may attach to the frame 144, wherein the fastener 145 is comprised of an adhesive fastener, a suction cup fastener, a hook and loop fastener, etc.

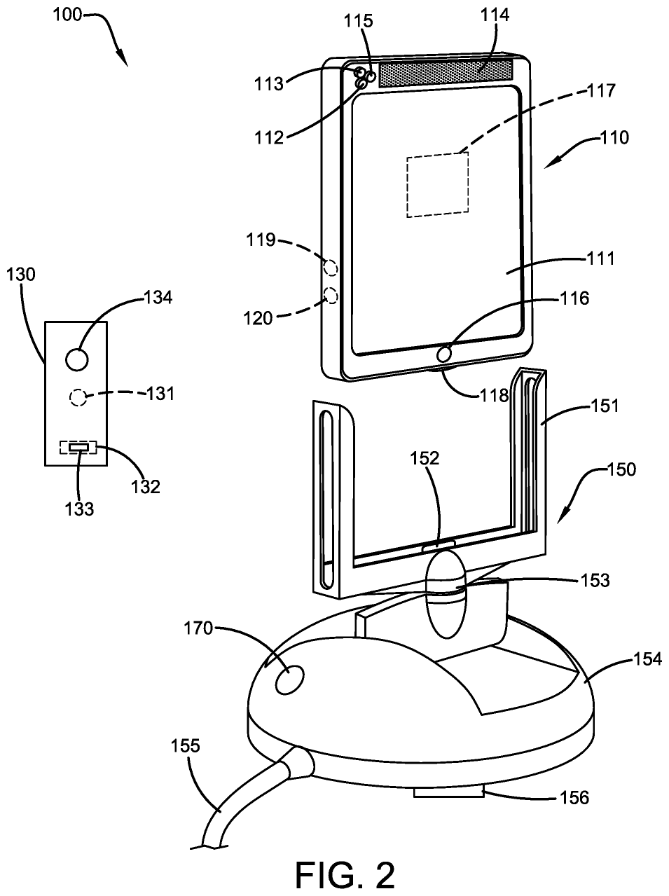

In a different embodiment, the tablet 110 can be received by a free-standing mount 150 with a frame 154 that can rest on a flat surface, as seen in FIG. 2. The frame 154 can further be secured to said surface via at least one fastener 156, such as, but not limited to, adhesive, hook and loop, non-slip rubber, magnet, etc.

In said embodiment, at least one portion of the tablet 110 is received by a receiving area 151 of a wall mount 150. The receiving area 151 may be in the form of a cradle, a molded area, or any other tablet 110 holding means known in the art. The receiving area 151 is comprised of at least one charging port 152, which is a reciprocating charging port to the charging port 118 of the tablet 110 and provides charge to the tablet 110 while receiving power from a 110 v/240 v power cord 155.

The receiving area 151 attaches to a frame 154 of the wall mount 150 via at least one rotation point 153. The point 153 may be a hinge, a ball and socket joint, or any other rotation point of the like that allows the receiving area 151 (and thus secured tablet 110) to be tilted upwards, downwards, left, or right by at least one degree. In this manner, the tablet 110 can be easily repositioned and angled towards an infant within a crib, a bed, etc.

In one embodiment, the rotation of the receiving area 141,151 about the rotation point 143,153 is motorized via a motorized rotation point 143,153. In this embodiment, movement of the rotation point 143,153 can be controlled by at least one remote 130. The remote 130 is comprised of at least one transmitter 131 in wireless electrical communication with at least one receiver 170 of either mount 140,150. At least one button 134 on the remote 130 can be used to move the rotation point 143,153 (and as a result, the tablet 110 within the receiving area 141, 151) during use. The remote 130 may be comprised of at least one disposable or rechargeable battery. The rechargeable battery 132 may be recharged by at least one charging port 133 (of any type known in the art) in one embodiment.

As noted, the tablet 110 is in wireless electrical communication with a mobile application 160 installed on a smart device. To do so, the tablet 110 may be comprised of at least one wireless transmitter 119 and at least one wireless receiver 120. The transmitter 119 and receiver 120 allow the tablet 110 to wirelessly communicate via Wi-Fi, Bluetooth, etc., to the mobile application 160 (and the smart device the mobile application 160 is installed on).

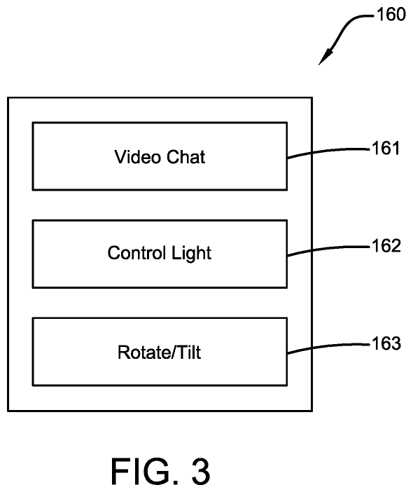

The mobile application 160 has a plurality of functions, as seen in FIG. 3. The mobile application 160 may allow a parent/caregiver to initiate a two-way video chat 161 using the smart device camera and display, and the camera 112 and display 111 of the tablet 110. The mobile application 160 may also allow a user to control the power (on/off), brightness level, illumination time, etc., of the light 115 to allow the light 115 to be used as a nightlight 162. Further, in an embodiment of the device 100, with a mount 140, 150 having a motorized rotation point 143, 153, the mobile application 160 can be used to remotely move the rotation point 143,153 to rotate the tablet 110 to enable a better view of an infant being monitored with the device 100.

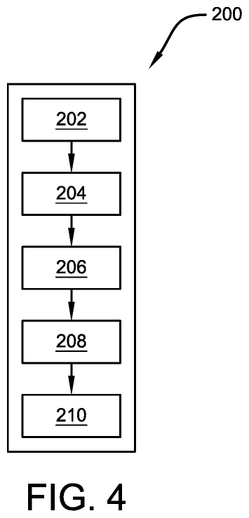

The present invention is also comprised of a first method of using 200 the device 100, as seen in FIG. 4. First, a device 100 is provided comprised of a mobile application 160, a tablet 110 comprised of a camera 112, a microphone 113, a speaker 114, a display screen 111, a charging port 118, and a wall mount 140 comprised of a receiving area 141 with a charging port 142 and a frame 144, wherein the receiving area 141 attaches to the frame 144 via a rotation point 143 [Step 202]. Then, the frame 144 can be attached to a wall (or another surface) using a fastener 145 [Step 204]. Next, the tablet 110 can be placed into the receiving area 141 such that the charging port 142 of the receiving area 141 contacts the charging port 118 of the tablet [Step 206]. Then, the receiving area 141 can be rotated about a rotation point 143 to position the tablet 110 such that the display screen 111 and camera 112 can be seen by an infant [Step 208]. Finally, a mobile application 160 can be used to perform a two-way video chat 161 with the infant in real-time using the camera 112, microphone 113, speaker 114, and display screen [Step 210].

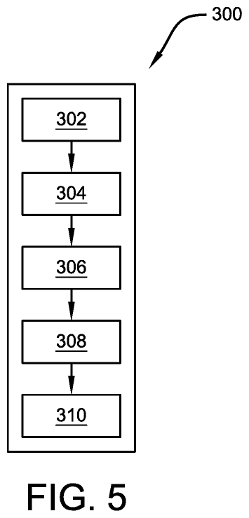

The present invention is also comprised of a second method of using 300 the device 100, as seen in FIG. 5. First, a device 100 is provided comprised of mobile application 160, a tablet 110 comprised of a camera 112, a microphone 113, a speaker 114, a display screen 111, and a charging port 118, and a free-standing mount 150 comprised of a receiving area 151 with a charging port 152 and a frame 154, wherein the receiving area 151 attaches to the frame 154 via a rotation point 153 [Step 302]. Then, the frame 154 can be placed on a flat surface [Step 304]. Next, the tablet 110 can be placed into the receiving area 151 such that the charging port 152 of the receiving area 151 contacts the charging port 118 of the tablet [Step 306]. Then, the receiving area 151 can be rotated about a rotation point 153 to position the tablet 110 such that the display screen 111 and camera 112 can be seen by an infant [Step 308]. Finally, a mobile application 160 can be used to perform a two-way video chat 161 with the infant in real-time using the camera 112, microphone 113, speaker 114, and display screen [Step 310].

In addition to performing two-way video chats, the device 100 can be used for one-way infant monitoring.

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “infant monitoring device” and “device” are interchangeable and refer to the infant monitoring device 100 of the present invention.

Notwithstanding the foregoing, the infant monitoring device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the infant monitoring device 100 as shown in the FIGS. are for illustrative purposes only, and that many other sizes and shapes of the infant monitoring device 100 are well within the scope of the present disclosure. Although the dimensions of the infant monitoring device 100 are important design parameters for user convenience, the infant monitoring device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An infant monitoring device comprising:
a tablet comprised of a battery, a display screen, a microphone, a speaker, a camera, and a first charging port;
a wall mount comprised of a frame, a receiving area comprised of a second charging port wherein the receiving area is attached to the frame via a rotation point; and
a mobile application in wireless electrical communication with the tablet.

2. An infant monitoring device of claim 1, wherein the mobile application is in wireless electrical communication with the wall mount.

3. An infant monitoring device of claim 1, wherein the rotation point is comprised of a motorized rotation point.

4. An infant monitoring device of claim 3, wherein the motorized rotation point can be rotated via the mobile application.

5. An infant monitoring device of claim 1, wherein receiving area receives the tablet.

6. An infant monitoring device of claim 1, wherein the display screen displays a live video feed from the mobile application.

7. An infant monitoring device of claim 1, wherein the mobile application displays a live video feed from the camera.

8. An infant monitoring device of claim 1, wherein the first charging port is received by the second charging port.

9. An infant monitoring device comprising:
a tablet comprised of a battery, a display screen, a microphone, a speaker, a camera, and a first charging port;
a free-standing mount comprised of a frame, a receiving area comprised of a second charging port wherein the receiving area is attached to the frame via a rotation point; and
a mobile application in wireless electrical communication with the tablet.

10. An infant monitoring device of claim 9, wherein the mobile application is in wireless electrical communication with the wall mount.

11. An infant monitoring device of claim 9, wherein the rotation point is comprised of a motorized rotation point.

12. An infant monitoring device of claim 11, wherein the motorized rotation point can be rotated via the mobile application.

13. An infant monitoring device of claim 9, wherein receiving area receives the tablet.

14. An infant monitoring device of claim 9, wherein the display screen displays a live video feed from the mobile application.

15. An infant monitoring device of claim 9, wherein the mobile application displays a live video feed from the camera.

16. An infant monitoring device of claim 9, wherein the first charging port is received by the second charging port.

17. An infant monitoring device of claim 9, wherein the frame is comprised of a fastener.

18. A method of using an infant monitoring device, the method comprising the following steps:
providing an infant monitoring device comprised of a mobile application, a tablet comprised of a camera, a microphone, a speaker, a display screen, and a charging port, and a mount comprised of a receiving area with a charging port, and a frame wherein the receiving area attaches to the frame via a rotation point;
placing the tablet within the receiving area;
rotating the receiving area via the rotation point; and
using the mobile application, the display, and the camera to perform a two-way video chat.

19. A method of using an infant monitoring device of claim 18, wherein the mount is comprised of a wall mount.

20. A method of using an infant monitoring device of claim 18, wherein the mount is comprised of a free-standing mount.
